(19) United States
(12) Patent Application Publication
(10) Pub. No.: US 2014/0263936 A1
(43) Pub. Date: Sep. 18, 2014

(54) MACHINE HEAT DISSIPATION DEVICE

(71) Applicant: CHRISTOPHER J. DESANTIS, WILMINGTON, NC (US)

(72) Inventor: CHRISTOPHER J. DESANTIS, WILMINGTON, NC (US)

(21) Appl. No.: 13/844,170

(22) Filed: Mar. 15, 2013

(51) Int. Cl. F16M 11/00

(52) U.S. Cl. CPC F16M 11/00
USPC 248/676

(57) ABSTRACT

The present invention is an apparatus designed to improve the ability of a machine, particularly a laptop computer, to dissipate heat by separating the machine cooling fan discharge from a nearby impermeable surface. In its broadest form, the inventor now presents the apparatus comprised from a base member that is minimalist in design and that is able to be contracted in size in at least two (2) differing dimensions (e.g., length and width, etc.). More specifically, the inventor now presents the apparatus comprised from a base member constructed from a system of elongated horizontal supports integrated with a plurality of footing members, the component parts of the base member having integrated means whereby the whole base member may be contracted in size in at least two (2) differing dimensions (e.g., length and width, etc.).

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND OF THE INVENTION

(a) Field of the Invention

The present invention is in the technical field of supporting bases for machines. More particularly, the present invention is in the technical field of supporting bases affording improved heat dissipation in supported machines. Still more particularly, the present invention is in the technical field of supporting bases affording improved heat dissipation in supported laptop computer.

(b) Background Art

Design and placement of a functional and efficient cooling fan discharge has long been a challenge of the mechanical design of devices and machines that generate a notable amount of heat during their operation. The generation of heat during operation is a problem common to many of the machines that modern humans experience in daily life including, but not limited to motor vehicles, televisions, refrigeration units, and computers. While common to both mechanical and electronic machines, the problem is particularly apparent in electronic machines due to the tendency of these machines to be placed in tight places such as bookshelves, entertainment cabinets, and computer desks, wherein cooling fan discharge and, therefore, outflow, is inhibited. In no singular case is the problem more apparent than the modern laptop computer wherein the cooling fan discharge is frequently located on the bottom of the computer housing, the aspect of the laptop computer that is specifically designed to be flush against the lap of a user or, otherwise, a tabletop, desktop, or other impermeable surface. Where there is a problem, technology will develop to provide a solution and, true to this statement, many inventors and inventions have attempted to address the problem of proper spacing of mechanical devices, particularly laptop computers, from impermeable surfaces to allow for proper cooling fan outflow from the device.

Accordingly, stands, pads, supports and devices utilized to improve the ability of a machine, and particularly a laptop computer, to dissipate heat generated during the operation of the machine are well known in the prior art. Occurring with particular frequency in the prior art are inventions improving the ability of a laptop computer to dissipate heat by separating the laptop cooling fan discharge from an impermeable surface upon which it would otherwise be situated.

An early seen commonality among the prior art improving the ability of a laptop computer to dissipate heat by separating the laptop cooling fan discharge from an impermeable surface upon which it would otherwise be situated is the positioning of the laptop computer upon an inventive panel either itself separating the computer from a lap, desktop, tabletop, or the like, or the panel utilizing some design characteristic such as channeling, wedging, or propping, to specifically facilitate cooling fan outflow from the base of the laptop computer. Examples of this approach to the problem may be found in MacEachern U.S. Pat. No. 6,682,040 granted Jan. 27, 2004 disclosing a heat dissipating laptop computer stand with adjustable tilt, Saad United States Patent Application Publication No. 2006/0243878 published on Nov. 2, 2006 disclosing a ventilation support for laptop computers, Panziera United States Patent Application Publication No. 2008/0061207 published Mar. 13, 2008 disclosing a support pad for a laptop computer, Richter United States Patent Application Publication No. 2009/0090834 published Apr. 9, 2009 disclosing a support box for supporting a laptop computer, Huang U.S. Pat. No. 8,052,109 granted Nov. 8, 2011 disclosing a cooling stand, and Hu U.S. Pat. No. 8,070,124 granted Dec. 6, 2011 disclosing a supporting stand with heat dissipation device. While each of these disclosures likely aptly solve the problem at hand, each may be characterized by a common shortcoming—the invention is typically large, cumbersome, and, in most cases, at least the size of the laptop computer itself. In this sense, the aforementioned inventions impose upon a user the further burden of storing and transporting a cumbersome and inconvenient panel or large rigid stand, an inconvenience that arguably renders the purported convenience of a the laptop computer itself moot.

Undoubtedly responsive to the above identified shortcoming in the prior art, inventors have attempted to address the problem of the storing and transport of a cumbersome and inconvenient panel or large rigid stand in one of two ways. First, the prior art has attempted to manage the problem of inconvenient storage and transport of a cumbersome panel or large rigid stand by producing the same in such way that it may be folded, broken down, or contracted for easier storage and/or transport. Examples of this approach to the problem may be found in Marceau United States Patent Application Publication No. 2004/0262485 published Dec. 30, 2004 disclosing a portable rest device for laptop computer, Sullivan U.S. Pat. No. 7,032,872 granted Apr. 25, 2006 disclosing a universal laptop computer mount, Thomas U.S. Pat. No. 7,207,540 granted Apr. 24, 2007 disclosing a portable support for laptop computer, Marceau U.S. Pat. No. 7,249,747 granted Jul. 31, 2007 disclosing a portable rest device for laptop computer, Freebairn United States Patent Application Publication No. 2008/0054149 published Mar. 6, 2008 disclosing a collapsible computer platform, Lee U.S. Pat. No. 7,600,736 granted Oct. 13, 2009 disclosing a lockable notebook stand, and Huang United States Patent Application Publication No. 2010/0214737 published Aug. 26, 2010 disclosing an extendable heat-dissipating base set for notebook computers. While these examples are no doubt an improvement upon the cumbersome and inconvenient panel or large rigid stand, the result of breaking down and/or folding or collapsing a bulky stand is that a user is left with a smaller, but nonetheless, bulky stand or competent part of an otherwise bulky stand. In this sense, the component parts or a bulky stand or a bulky stand having a significantly reduced spatial footprint are still nonetheless large, cumbersome, and sizable when compared to the spatial footprint of most modern laptop computers. Accordingly, a user must account not only for storage of the portable laptop computer, but also storage and transport of the component parts of the bulky stand or the reduced size bulky stand itself. This remains an unnecessary inconvenience frequently encountered with the examples in the prior art.

The second way in which inventors have attempted to address the problem of the storing and transport of a cumbersome and inconvenient panel or large rigid stand is through minimalist design. Examples of this approach include Hsu U.S. Pat. No. 5,511,758 granted Apr. 30, 1996 disclosing a folding stand for notebook computers, Lord U.S. Pat. No. 6,527,241 granted Mar. 4, 2003 disclosing an apparatus for cooling a laptop computer, Lord United States Patent Application Publication No. 2009/0179131 published Jul. 16, 2009 disclosing a laptop cooling stand with fan, Leung U.S. Pat. No. 7,600,730 granted on Oct. 13, 2009 disclosing a portable computer stand, and Petrie United States Patent Application Publication No. 2009/0321605 published on Dec. 31, 2009 disclosing a laptop stand. The cited Lord disclosures makes excellent progress in reducing bulk of the laptop computer stand through the abandonment of bulky paneling as a base structural feature of the stand, but even the Lord minimalist designs leave a stand of substantial enough size that the stand must be specifically negotiated during storage or transfer. Likewise, the cited Petrie disclosure is very successful in terms of minimalist design, however, the feature that the device breaks into separate parts and must be stored as such between uses always raises the concern that parts may be lost, thus, rendering the device inoperable.

The present inventor regards the cited Leung and Hsu disclosures as the best solutions known in the prior art to the combined problem of (i) improving the ability of a laptop computer to dissipate heat by separating the laptop cooling fan discharge from an impermeable surface upon which it would otherwise be situated and (ii) storing and transport of a cumbersome and inconvenient panel or large rigid stand. The Leung invention separates the cooling fan discharge of a typical laptop computer from an impermeable surface upon which the laptop might rest and does so utilizing a device that collapses to a relatively small size. However, the fact that the Leung invention is intended to only prop the rear bottom portion of a laptop computer, thus better exposing the cooling fan discharge, is problematic in that a device that only props the rear of a laptop computer and does not provide for support of the front bottom of the computer is ill-suited for use in the lap of a user or under any condition wherein the front bottom of the laptop is not resting on a relatively even surface. As opposed to the Leung invention, the Hsu invention is specifically designed to support the entirety of the laptop computer base and still is designed to collapse to a relatively small size. However, both the Leung and Hsu disclosures are further limited in that the respective inventions may only be reduced in size for purposes of storage and transport in one dimension—lateral length of the device. Further, in terms of materials, composition and structure, both the Leung and Hsu disclosures appear to contemplate inventions having many composite parts and molded pieces and appear to contemplate inventions that, therefore, would be costly to manufacture.

The cited prior art references go a long way to address the problem of improving the ability of a laptop computer to dissipate heat, but there remains need for devices that solve the problem while minimizing the spatial footprint of the device without sacrificing function. There is a specific need for a device that solves the problem of improving the ability of a laptop computer to dissipate heat while providing stable support for the laptop computer and remaining functional in use and in storage and transport.

### BRIEF SUMMARY OF THE INVENTION

The present invention is an apparatus designed to improve the ability of a machine, particularly a laptop computer, to dissipate heat by separating the machine cooling fan discharge from a nearby impermeable surface. In its broadest form, the inventor now presents the apparatus comprised from a base member that is minimalist in design and that is able to be contracted in size in at least two (2) differing dimensions (e.g., length and width, etc.). More specifically, the inventor now presents the apparatus comprised from a base member constructed from a system of elongated horizontal supports integrated with a plurality of footing members, the component parts of the base member having integrated means whereby the whole base member may be contracted in size in at least two (2) differing dimensions (e.g., length and width, etc.).

For the purposes of this utility patent application, the phraseology “elongated horizontal support” shall mean a horizontally oriented support of rigid material, or a support comprising component parts formed from a rigid material, having a length being at least twice the thickness of the horizontally oriented support. The material composition of the horizontally oriented support or the component parts comprising a support shall be any material sufficiently rigid as to not deform under the weight of a machine contemplated to be supported by the device disclosed herein, including, but not limited to, iron, steel, aluminum, plastic, ceramic, carbon composite, polyvinyl chloride (PVC) or the like.

For the purposes of this utility patent application, the phraseology “footing member” shall mean any member comprised of a material sufficiently durable to sustain the wear and tear of repeated use of the disclosed device to which an elongated horizontal support is attached that provides constant contact with a surface during use and, in fact, supports at least one elongated horizontal supports above said surface. Though a “footing member” may be made of any material sufficiently durable to sustain the wear and tear of repeated use of the disclosed device, it is specifically contemplated that a “footing member” may be made from a substantially slip-resistant material for purposes of stability of the device during use.

With more specificity, the present invention is contemplated to be a base member upon which a machine, particularly a laptop computer, may rest, the base member being expressly not constructed utilizing a panel, solid plane of material, or flat surface as the primary structural component, but rather being comprised of a system of interconnected elongated horizontal supports and footing members, thus making the device far less bulky than the disclosures found in the prior art. It is further contemplated that any elongated horizontal support will be capable of contraction by means integrated within the elongated horizontal support, including, but not limited to telescopic means integrated within the elongated horizontal support that allow for the telescoping of the support and/or hinge means integrated within the elongated horizontal support that allow for the folding of the support. By the telescopic or folding contraction of the elongated horizontal supports, the base member itself is afforded the capacity to telescopically contract or contract by folding in at least two (2) varying dimensions.

It is a present object of the now disclosed invention to provide an apparatus that serves to space the cooling fan discharge of a mechanical or electronic device away from a surface that may obstruct the discharge and impede the outflow of heated air, thus allowing the cooling system of the mechanical or electronic device to operate with greater efficiency.

It is a further object of the now disclosed invention to provide an apparatus that serves to space the cooling fan discharge of a laptop computer away from a surface that may obstruct the discharge and impede the outflow of heated air, thus allowing the cooling system of the laptop computer to operate with greater efficiency.

It is a further object of the now disclosed invention to provide an apparatus that is convenient to store and transport.

It is a further object of the now disclosed invention to provide an apparatus that has the capacity to expand and contract as needed to accommodate a large number of varying shapes, contours and sizes of laptop computer.

It is a further object of the now disclosed invention to provide an apparatus that has the capacity to expand and contract without sacrificing the utility of the apparatus in serving to space the cooling fan discharge of a laptop computer away from a surface that may obstruct the discharge and impede the outflow of heated air, thus allowing the cooling system of the laptop computer to operate with greater efficiency.

It is a further object of the now disclosed invention to provide an apparatus that may be contracted to a relatively small spatial footprint, thus facilitating ease of storage, transport and handling, generally.

It is a further object of the now disclosed invention to provide an apparatus that may be manufactured cost effectively.

### BRIEF DESCRIPTION OF THE SEVERAL VIEWS OF THE DRAWING(S)

FIG. 1 is a top view of a first preferred embodiment of the present invention;

FIG. 2 is a bottom view of the first preferred embodiment of the present invention;

FIG. 3 is a bottom view of an alternative configuration of the first preferred embodiment of the present invention;

FIG. 4 is a perspective view of the first preferred embodiment of the present invention depicting the present invention in use;

FIG. 5 is a top view of a secondary preferred embodiment of the present invention;

FIG. 6 is a right side view of the secondary preferred embodiment of the present invention.

FIG. 7 is a left side view of the secondary preferred embodiment of the present invention.

FIG. 8 is a top view of an alternative configuration of the secondary preferred embodiment of the present invention;

### DETAILED DESCRIPTION OF THE INVENTION

Referring now to the invention in more detail, in FIG. 1 there is shown a top view of a first preferred embodiment of the inventive apparatus, the apparatus comprising a first elongated horizontal support constructed from a first hollow length of rigid material 61 and a second hollow length of rigid material 62 concentric with and of smaller gauge than the first hollow length of rigid material 61; a second elongated horizontal support constructed from a third hollow length of rigid material 65 and a fourth hollow length of rigid material 66 concentric with and of smaller gauge than the third hollow length of rigid material 65; a third elongated horizontal support constructed from a fifth hollow length of rigid material 54 and a sixth hollow length of rigid material 53 concentric with and of smaller gauge than the fifth hollow length of rigid material 54; a fourth elongated horizontal support constructed from a seventh hollow length of rigid material 58 and an eighth hollow length of rigid material 56 concentric with and of smaller gauge than the seventh hollow length of rigid material 58; a first elbow 64 connecting the second hollow length of rigid material 62 to the third hollow length of rigid material 65; a second elbow 52 connecting the fourth hollow length of rigid material 66 to the sixth hollow length of rigid material 53; a third elbow 55 connecting the fifth hollow length of rigid material 54 to the eight hollow length of rigid material 56; a fourth elbow 59 connecting the seventh hollow length of rigid material 58 to the first hollow length of rigid material 61; a first footing member 63 affixed to the first elbow 64; a second footing member 51 affixed to the second elbow 52; a third footing member 57 affixed to the third elbow 55; and a fourth footing member 60 affixed to the fourth elbow 59.

Referring now to the invention in more detail, in FIG. 2 there is shown a bottom view of the first preferred embodiment of the inventive apparatus also depicted in FIG. 1, the apparatus as shown in FIG. 2 comprising a first elongated horizontal support constructed from the first hollow length of rigid material 61 and the second hollow length of rigid material 62 concentric with and of smaller gauge than the first hollow length of rigid material 61; a second elongated horizontal support constructed from the third hollow length of rigid material 65 and the fourth hollow length of rigid material 66 concentric with and of smaller gauge than the third hollow length of rigid material 65; a third elongated horizontal support constructed from the fifth hollow length of rigid material 54 and the sixth hollow length of rigid material 53 concentric with and of smaller gauge than the fifth hollow length of rigid material 54; a fourth elongated horizontal support constructed from the seventh hollow length of rigid material 58 and the eighth hollow length of rigid material 56 concentric with and of smaller gauge than the seventh hollow length of rigid material 58; the first footing member 63 affixed at the junction of the second hollow length of rigid material 62 and the third hollow length of rigid material 65; the second footing member 51 affixed at the junction of the fourth hollow length of rigid material 66; the third footing member 57 affixed at the junction of the fifth hollow length of rigid material 54 and the eighth hollow length of rigid material 56; and the fourth footing member 60 affixed at the junction of the seventh hollow length of rigid material 58 and the first hollow length of rigid material 61. It is noteworthy that the elbows depicted in FIG. 1 are not visible in the view of FIG. 2 due to obstruction by the first footing member 63, second footing member 51, third footing member 57, and fourth footing member 60, respectively.

Referring now to the invention in more detail, in FIG. 4 there is shown a top view of the first preferred embodiment of the inventive apparatus also depicted in FIG. 1 and FIG. 2 as the same would appear in use supporting a laptop computer 67 and spacing the bottom of the laptop computer 67 away from the impermeable surface upon which the same would rest in the absence of the now disclosed invention. Specifically there is shown the fourth elongated horizontal support constructed from the seventh hollow length of rigid material 58 and the eighth hollow length of rigid material 56 concentric with and of smaller gauge than the seventh hollow length of rigid material 58; the third elbow 55 and the fourth elbow 59 attached at each end of the fourth elongated horizontal support constructed from the seventh hollow length of rigid material 58 and the eighth hollow length of rigid material 56 concentric with and of smaller gauge than the seventh hollow length of rigid material 58; the third footing member 57 affixed to the third elbow 55; and the fourth footing member 60 affixed to the fourth elbow 59. Notably the remaining structural features of the first preferred embodiment depicted in FIG. 4 are obstructed from view by the placement of the laptop computer 67.

In more detail, still referring to the invention of FIG. 1, FIG. 2, and FIG. 4, the first preferred embodiment, as shown, depicts how the invention might appear while fully extended and in use. Specifically, the elongated horizontal supports of the embodiment are at full extension, exposing nearly the entire surface area of both the first hollow length of rigid material 61 and the second hollow length of rigid material 62, the third hollow length of rigid material 65 and the fourth hollow length of rigid material 66, the fifth hollow length of rigid material 54 and the sixth hollow length of rigid material 53, and the seventh hollow length of rigid material 58 and the eighth hollow length of rigid material 56. Further, the laptop computer 67 rests upon the perimeter of elongated horizontal supports formed of the first hollow length of rigid material 61, the second hollow length of rigid material 62, the first elbow 64, the third hollow length of rigid material 65, the fourth hollow length of rigid material 66, the second elbow 52, the fifth hollow length of rigid material 54, the sixth hollow length of rigid material 53, the third elbow 55, the seventh hollow length of rigid material 58, the eighth hollow length of rigid material 56, and the fourth elbow 59. The first footing member 63, second footing member 51, third footing member 57 and fourth footing member 60 serve to suspend the perimeter of elongated horizontal supports above an impermeable surface, thus separating the cooling fan discharge, assumed to be on the bottom panel of the laptop computer 67 from direct or near contact with the surface and thereby improving outflow from the cooling fan.

Referring now to the invention in more detail, in FIG. 3 there is shown a bottom view of the first preferred embodiment of the inventive apparatus as also depicted in FIG. 1, FIG. 2 and FIG. 4, as the same would appear in a fully contracted configuration. Namely there is shown the apparatus fully contracted and thereby displaying only the first footing member 63, second footing member 51, third footing member 57, and fourth footing member 60, along with the first hollow length of rigid material 61, the third hollow length of rigid material 65, the fifth hollow length of rigid material 54, and the seventh hollow length of rigid material 58. As mentioned in the detailed descriptions of FIG. 1, the counterpart hollow lengths of rigid material to each of the first hollow length of rigid material 61, the third hollow length of rigid material 65, the fifth hollow length of rigid material 54, and the seventh hollow length of rigid material 58 were concentric with and of smaller gauge than their respective first hollow length of rigid material 61, the third hollow length of rigid material 65, the fifth hollow length of rigid material 54, and the seventh hollow length of rigid material 58 counterparts and have, thus, been telescopically overtaken by their first hollow length of rigid material 61, the third hollow length of rigid material 65, the fifth hollow length of rigid material 54, and the seventh hollow length of rigid material 58 counterparts in the depiction of FIG. 3. It is the integrated telescoping functionality of the elongated horizontal supports that allows the first embodiment to contract in both a length and width dimension.

In further detail, still referring to the first preferred embodiment of FIG. 1, FIG. 2, FIG. 3, and FIG. 4, although the component parts 58 59 54 53 66 65 62 61 of the telescoping elongated horizontal supports may be made of any sufficiently rigid material that they resist deformation under the weight of a machine or laptop computer 67, the inventor presently contemplates that the same may be inexpensively formed of a rigid plastic, particularly polyvinyl chloride (PVC). Likewise, although the footing members 57 51 63 60 may be made of any sufficiently durable material to sustain a substantial number of uses of apparatus, the inventor presently contemplates that the same may be preferably formed form a substantially slip resistant material and likely some type of rubber. It should be noted that the elbow components 64 51 55 59, when necessary, are contemplated of like composition with the component parts 58 59 54 53 66 65 62 61 of the telescoping elongated horizontal supports, though appropriately molding the embodiment is contemplated to obviate the need for the elbow components 64 51 55 59 altogether. The footing members 57 51 63 60 may be affixed to the elongated horizontal support perimeter by any means sufficient and durable, though the inventor expressly contemplates the footing members 57 51 63 60 being affixed by means of a strong and durable adhesive.

Referring now to the invention in more detail, in FIG. 5 there is shown a top view of a second preferred embodiment of the now disclosed apparatus, the apparatus comprising a first elongated horizontal support constructed from a first hollow length of rigid material 73 and a second length of hollow rigid material 71 concentric with and of smaller gauge than the first hollow length of rigid material 73; a second elongated horizontal support constructed from a third hollow length of rigid material 70 and a fourth length of hollow rigid material 69 concentric with and of smaller gauge than the third hollow length of rigid material 70, and a fifth hollow length of rigid material 76 and a sixth length of hollow rigid material 74 concentric with and of smaller gauge than the fifth hollow length of rigid material 76; a first slip-resistant pad 72; a second slip-resistant pad 68; a third slip resistant pad 75; and a fourth slip resistant pad 77. Footing members present cannot be seen from the view of FIG. 5 due to obstruction.

Referring now to the invention in more detail, in FIG. 6 there is shown a right perspective view of the second preferred embodiment of the now disclosed apparatus, also shown in FIG. 5, the apparatus depicted in FIG. 6 comprising a first elongated horizontal support constructed from a first hollow length of rigid material 73 and a second length of hollow rigid material 71 concentric with and of smaller gauge than the first hollow length of rigid material 73; a second elongated horizontal support constructed from a third hollow length of rigid material 70 and a fourth length of hollow rigid material 69 concentric with and of smaller gauge than the third hollow length of rigid material 70, and a fifth hollow length of rigid material 76 and a sixth length of hollow rigid material 74 concentric with and of smaller gauge than the fifth hollow length of rigid material 76; a first slip-resistant pad 72; a second slip-resistant pad 68; a third slip resistant pad 75; a fourth slip resistant pad 77; a first footing member 78; and a second footing member 79. As in FIG. 5, a third footing member present cannot be seen from the view of FIG. 6 due to obstruction.

Referring now to the invention in more detail, in FIG. 7 there is shown a left perspective view of the second preferred embodiment of the now disclosed apparatus, also shown in FIG. 5 and FIG. 6, the apparatus depicted in FIG. 7 comprising a first elongated horizontal support constructed from a first hollow length of rigid material 73 and a second length of hollow rigid material 71 concentric with and of smaller gauge than the first hollow length of rigid material 73; a second elongated horizontal support constructed from a third hollow length of rigid material 70 and a fourth length of hollow rigid material 69 concentric with and of smaller gauge than the third hollow length of rigid material 70, and a fifth hollow length of rigid material 76 and a sixth length of hollow rigid material 74 concentric with and of smaller gauge than the fifth hollow length of rigid material 76; a first slip-resistant pad 72; a second slip-resistant pad 68; a third slip resistant pad 75; a fourth slip resistant pad 77; a first footing member 78; and a third footing member 80. As in FIG. 5 and FIG. 6, the second footing member present cannot be seen from the view of FIG. 7 due to obstruction.

In more detail, still referring to the invention of FIG. 5, FIG. 6, and FIG. 7, the second preferred embodiment, as shown, depicts how the invention might appear while fully extended and in use. Specifically, the elongated horizontal supports of the embodiment are at full extension, exposing nearly the entire surface area of both the first hollow length of rigid material 73 and the second length of hollow rigid material 71, the third hollow length of rigid material 70 and the fourth length of hollow rigid material 69, and the fifth hollow length of rigid material 76 and the sixth length of hollow rigid material 74. Further, a machine or laptop computer is contemplated to rest upon the first slip-resistant pad 72, the second slip-resistant pad 68, the third slip-resistant pad 75, and the fourth slip-resistant pad 77. The first footing member 78, the second footing member 79, and the third footing member 80 serve to suspend the “T”-structure of elongated horizontal supports above an impermeable surface, thus separating the cooling fan discharge, assumed to be on the bottom panel of the machine or laptop computer supported, from direct or near contact with the surface and thereby improving outflow from the cooling fan.

Referring now to the invention in more detail, in FIG. 8 there is shown a top view of the second preferred embodiment of the inventive apparatus as also depicted in FIG. 5, FIG. 6 and FIG. 7, as the same would appear in a fully contracted configuration. Namely there is shown the apparatus fully contracted and thereby displaying only the first slip-resistant pad 72, the second slip-resistant pad 68; the third slip-resistant pad 75, the fourth slip resistant pad 77, along with the first hollow length of rigid material 73, the third hollow length of rigid material 70, and the fifth hollow length of rigid material 76. As mentioned in the detailed descriptions of FIG. 5, FIG. 6, and FIG. 7, the counterpart hollow lengths of rigid material 71 69 74 to each of the first hollow length of rigid material 73, the third hollow length of rigid material 70, and the fifth hollow length of rigid material 76 were concentric with and of smaller gauge than their respective first hollow length of rigid material 73, the third hollow length of rigid material 70, and the fifth hollow length of rigid material 76 counterparts and have, thus, been telescopically overtaken by their first hollow length of rigid material 73, the third hollow length of rigid material 70, and the fifth hollow length of rigid material 76 counterparts in the depiction of FIG. 8. It is the integrated telescoping functionality of the elongated horizontal supports that allows the second embodiment to contract in both a length and width dimension.

In further detail, still referring to the second preferred embodiment of FIG. 5, FIG. 6, FIG. 7, and FIG. 8, although the component parts 71 69 74 73 70 76 of the telescoping elongated horizontal supports may be made of any sufficiently rigid material that they resist deformation under the weight of a machine or laptop computer, the inventor presently contemplates that the same may be inexpensively formed of a rigid plastic, particularly polyvinyl chloride (PVC). Likewise, although the footing members 78 79 80 may be made of any sufficiently durable material to sustain a substantial number of uses of apparatus, the inventor presently contemplates that the same may be preferably formed form a substantially slip-resistant material and likely some type of rubber. Likewise, although the slip-resistant pads 72 68 77 75 may be made of any sufficiently durable material to sustain a substantial number of uses of apparatus, the inventor presently contemplates that the same may be preferably formed form a substantially slip-resistant material and likely some type of rubber. The footing members 78 79 80 may be affixed to the elongated horizontal support “T”-structure by any means sufficient and durable, though the inventor expressly contemplates the footing members 78 79 80 being affixed by means of a strong and durable adhesive. Likewise, the slip-resistant pads 72 68 77 75 may be affixed to the elongated horizontal support “T”-structure by any means sufficient and durable, though the inventor expressly contemplates the slip-resistant pads 72 68 77 75 being affixed by means of a strong and durable adhesive.

Reference throughout the specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout the specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

It is understood that the above described embodiments are only illustrative of the application of the principles of the present invention. The present invention may be embodied in other specific forms without departing from its spirit or essential characteristics. The described embodiment, including the best mode, is to be considered in all respects only as illustrative and not restrictive. The scope of the invention is, therefore, indicated by the appended claims, if any, in conjunction with the foregoing description.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. An apparatus spacing the cooling fan outflow of a machine from a surface, the apparatus comprising a base member constructed from a plurality of elongated horizontal supports and a plurality of footing members, and means whereby the base member may be contracted in at least two dimensions.

2. The apparatus according to claim 1 wherein the base member is constructed from at least two elongated horizontal supports.

3. The apparatus according to claim 2 wherein an end of a first elongated horizontal support is attached to a second elongated horizontal support at its midpoint.

4. The apparatus according to claim 2 wherein an end of a first elongated horizontal support is attached to a second elongated horizontal support at its endpoint.

5. The apparatus according to claim 2 wherein the base member is constructed from at least three elongated horizontal supports.

6. The apparatus according to claim 5 wherein the base member is constructed from at least four elongated horizontal supports.

7. The apparatus according to claim 6 wherein the means whereby the base member may be contracted is by folding facilitated by hinging means integrated within the elongated horizontal supports comprising the base member.

8. The apparatus according to claim 6 wherein the means whereby the base member may be contracted are telescoping means integrated within the elongated horizontal supports comprising the base member.

9. The apparatus according to claim 5 wherein the means whereby the base member may be contracted are telescoping means integrated within the elongated horizontal supports comprising the base member.

10. The apparatus according to claim 5 wherein the means whereby the base member may be contracted is by folding facilitated by hinging means integrated within the elongated horizontal supports comprising the base member.

11. The apparatus according to claim 2 wherein the means whereby the base member may be contracted are telescoping means integrated within the elongated horizontal supports comprising the base member.

12. The apparatus according to claim 2 wherein the means whereby the base member may be contracted is by folding facilitated by hinging means integrated within the elongated horizontal supports comprising the base member.

13. The apparatus according to claim 1 wherein the elongated horizontal supports comprise two hollow concentric component parts, each component part formed of a rigid material.

14. The apparatus according to claim 13 wherein the means whereby the base member may be contracted are telescoping means integrated within the elongated horizontal supports comprising the base member.

15. The apparatus according to claim 1 wherein the elongated horizontal supports comprise two component parts adjoined by hinging mechanism, each component part formed of a rigid material.

16. The apparatus according to claim 15 wherein the means whereby the base member may be contracted is by folding facilitated by hinging means integrated within the elongated horizontal supports comprising the base member.

17. The apparatus according to claim 1 wherein the means whereby the base member may be contracted are telescoping means integrated within the elongated horizontal supports comprising the base member.

18. The apparatus according to claim 1 wherein the means whereby the base member may be contracted is by folding facilitated by hinging means integrated within the elongated horizontal supports comprising the base member.

19. An apparatus spacing the cooling fan outflow of a laptop computer from a surface, the apparatus comprising a base member constructed from two elongated horizontal supports configured so that an end of a first elongated horizontal support is attached to a second elongated horizontal support at its midpoint, the first elongated horizontal support having a slip-resistant footing member at its non-attached end and the second elongated horizontal support having a slip-resistant footing member at each end, and means whereby the first elongated horizontal support may be contracted and the second elongated horizontal support may be separately contracted on each side of the point of attachment of the first elongated horizontal support.

20. The apparatus according to claim 19 wherein the means whereby the elongated horizontal supports may be contracted are telescoping means integrated within the elongated horizontal supports.

21. The apparatus according to claim 19 wherein the means whereby the elongated horizontal supports may be contracted is by folding facilitated by hinging means integrated within the elongated horizontal supports.

22. An apparatus spacing the cooling fan outflow of a laptop computer from a surface, the apparatus comprising a base member constructed from four elongated horizontal supports configured in a rectangular perimeter, so that each end of an elongated horizontal support adjoins the end of another elongated horizontal support at each corner of the rectangular perimeter, one slip-resistant footing member affixed to the bottom of the base member at each corner of the rectangular perimeter, and means whereby the elongated horizontal supports may be contracted.

23. The apparatus according to claim 22 wherein the means whereby the elongated horizontal supports may be contracted are telescoping means integrated within the elongated horizontal supports.

24. The apparatus according to claim 22 wherein the means whereby the elongated horizontal supports may be contracted is by folding facilitated by hinging means integrated within the elongated horizontal supports.
